(19) United States
(12) Patent Application Publication
(10) Pub. No.: US 2019/0316321 A1
(43) Pub. Date: Oct. 17, 2019

(54) VIBRATING RIPPER FOR DEMOLITION

(71) Applicant: SOCOMEC - SOCIETA' COSTRUZIONI MECCANICHE SOCIETA' PER AZIONI, Medesano (IT)

(72) Inventors: Fabio Maria GAZZA, Parma, Loc. Vigatto (IT); Gabriele AMORFINI, Licciana Nardi (IT)

(73) Assignee: SOCOMEC - SOCIETA' COSTRUZIONI MECCANICHE SOCIETA' PER AZIONI, Medesano (IT)

(21) Appl. No.: 16/381,578

(22) Filed: Apr. 11, 2019

(30) Foreign Application Priority Data
Apr. 13, 2018 (IT) 102018000004470

(51) Int. Cl. E02F 5/32; B06B 1/16

(52) U.S. Cl. CPC E02F 5/326; B06B 1/16

(57) ABSTRACT

A vibrating ripper for demolition comprising a chassis, a vibrating assembly supported by the chassis so that it can move with an alternating translational motion along a work direction between a first stroke limit position and a second stroke limit position, and at least one demolition tool associated with the vibrating assembly.

In the second stroke limit position, the vibrating assembly is spaced further from the chassis with respect to the first stroke limit position.

The vibrating assembly comprises a main body associated with at least one pair of oppositely rotating eccentric masses actuated rotationally by at least one motor element.

The particularity of the invention resides in that it comprises means for detecting an abnormal movement of the vibrating assembly along the work direction beyond at least one of the stroke limit positions.

The present invention relates to a vibrating ripper for demolition.

So-called vibrating rippers are known for the demolition of materials of medium-low hardness, such as chalk, limestone or slate, and in use are mated to the end of the work arm of an excavator in order to perform earth-moving work.

These rippers are essentially constituted by a chassis associable with the arm of the excavator, an assembly that vibrates along a work direction and is supported by the chassis, and at least one demolition tool, such as a tooth, connected to the vibrating assembly. This tool, as a result of the vibrations transmitted by the vibrating body, is adapted to progressively break up the material to be demolished.

The vibrating assembly is associated with the chassis by virtue of connection means with one degree of freedom in alternating sliding motion along the work direction. These connection means can be, for example, of the type of a pair of parallel linkages interposed between the chassis and the vibrating assembly so as to define an articulated parallelogram.

Vibration damping means are interposed between the chassis and the vibrating assembly so as to isolate the chassis and not transfer unwanted stresses to the arm of the excavator.

The vibrating assembly comprises a body associated with at least one pair of oppositely rotating eccentric masses, which are adapted to generate unidirectional vibrations having a predefined breadth along the work direction. These eccentric masses are actuated rotationally by a hydraulic motor associated with the corresponding rotation axes or with the rotation axis of an auxiliary gear acting as a rotation rate step-up or step-down system. For example, said motor can be mated directly to the rotation axis of one of the two masses and be associated with the rotation axis of the other eccentric mass by means of a transmission gear.

Such rippers are, therefore, provided with a hydraulic circuit that comprises a high-pressure line associated with the intake of the hydraulic motor and a low-pressure line associated with the discharge of said motor, which during use are placed in fluid connection respectively to a feed pump and to a discharge tank, which are normally provided on board the excavator.

Such rippers are generally sized to interact with materials having a mechanical compression strength of less than 100 MPa or even more, but with a stratification of the rock not greater than 50-60 cm, so as to contain the breadth of the oscillations of the vibrating assembly and of the tool associated therewith within a maximum value predefined during design.

These rippers of the known type are not free from drawbacks, which include the fact that if the tool acts during work on portions of material having a greater compressive strength, abnormal oscillations of the vibrating body with respect to the chassis are generated as a result of the reaction provided by said material to the action of the tool, are broader than said maximum value and risk transferring unwanted stresses to the excavator.

Such stresses produce vibrations which, besides being unpleasant for the operator on board the machine, can be harmful over time for the components involved if the assigned operator does not intervene promptly to reduce the hydraulic power supplied to the motor of the vibrating assembly.

It is very clear that in a quarry there can be regions constituted by materials having different compression strength characteristics, even greater than those for which the ripper has been sized. Moreover, the assigned operators, while performing an earth-moving process, have no way to verify preliminarily the type of material on which they have to intervene region by region.

Therefore, such abnormal operating situations can occur rather frequently and in a completely sudden way.

The aim of the present invention is to eliminate the drawbacks mentioned above of the background art by devising a vibrating ripper for demolition that allows to reduce in an automatic and prompt manner the supply power of the vibrating assembly if abnormal oscillations thereof occur, for example, after an impact of the tool with a portion of a particularly hard material during a work step.

Within this aim, an object of the present invention is to ensure comfortable and safe working conditions for the assigned operators, as well as to preserve the durability of the components both of the ripper and of the excavator to which it is coupled.

Another object of the present invention is to have an extremely simple structure, such as to allow also the modification of conventional existing rippers, as well as the production of new rippers according to the invention.

Another object of the present invention is to have a structure that is simple, relatively easy to provide in practice, safe in use, effective in operation, and relatively low in cost.

This aim and these and other objects are all achieved by a vibrating ripper for demolition comprising a chassis, a vibrating assembly supported by said chassis so that it can move with an alternating translational motion along a work direction between a first stroke limit position and a second stroke limit position, in the second stroke limit position the vibrating assembly being spaced further from the chassis with respect to the first stroke limit position, and at least one demolition tool associated with said vibrating assembly, the vibrating assembly comprising a main body associated with at least one pair of oppositely rotating eccentric masses which are actuated rotationally by at least one motor element, characterized in that it comprises means for detecting an abnormal movement of said vibrating assembly along said work direction beyond at least one of said stroke limit positions, which are functionally associated with means for the at least partial and at least temporary reduction of the supply power of said at least one motor element.

Further characteristics and advantages of the present invention will become better apparent from the detailed description of a preferred but not exclusive embodiment of a vibrating ripper for demolition, illustrated by way of non-limiting example in the accompanying drawings, wherein:

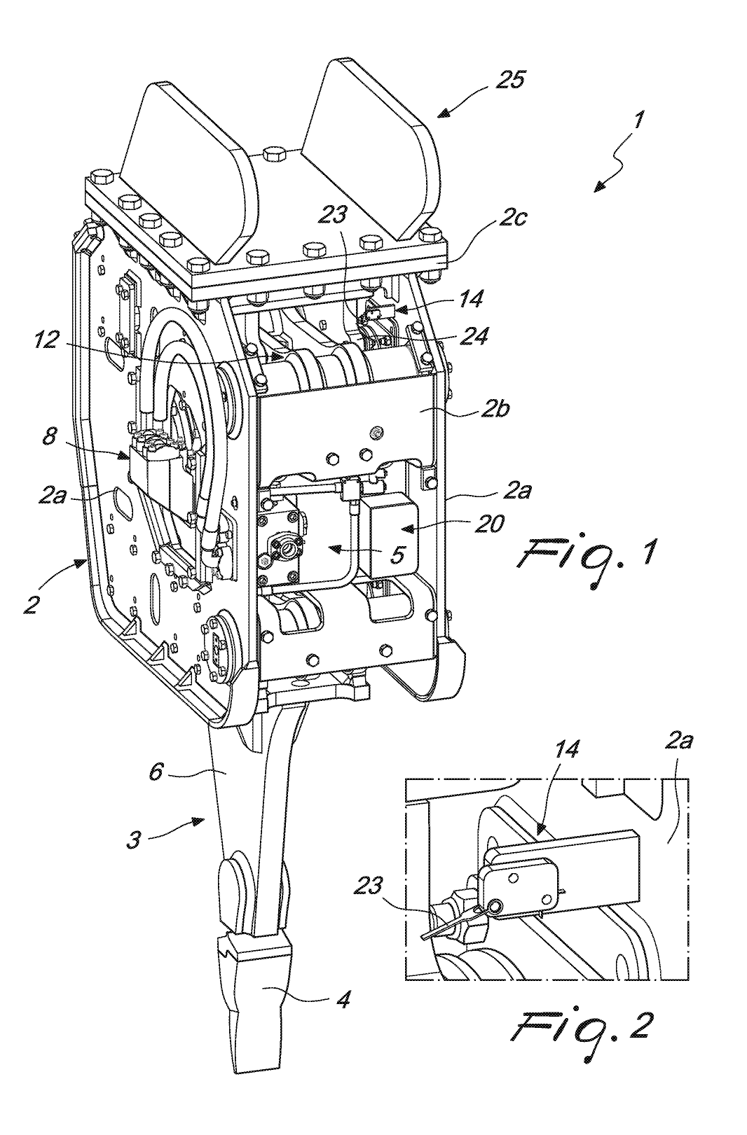

FIG. 1 is a perspective view of a vibrating ripper for demolition, according to the invention, without some external covering elements;

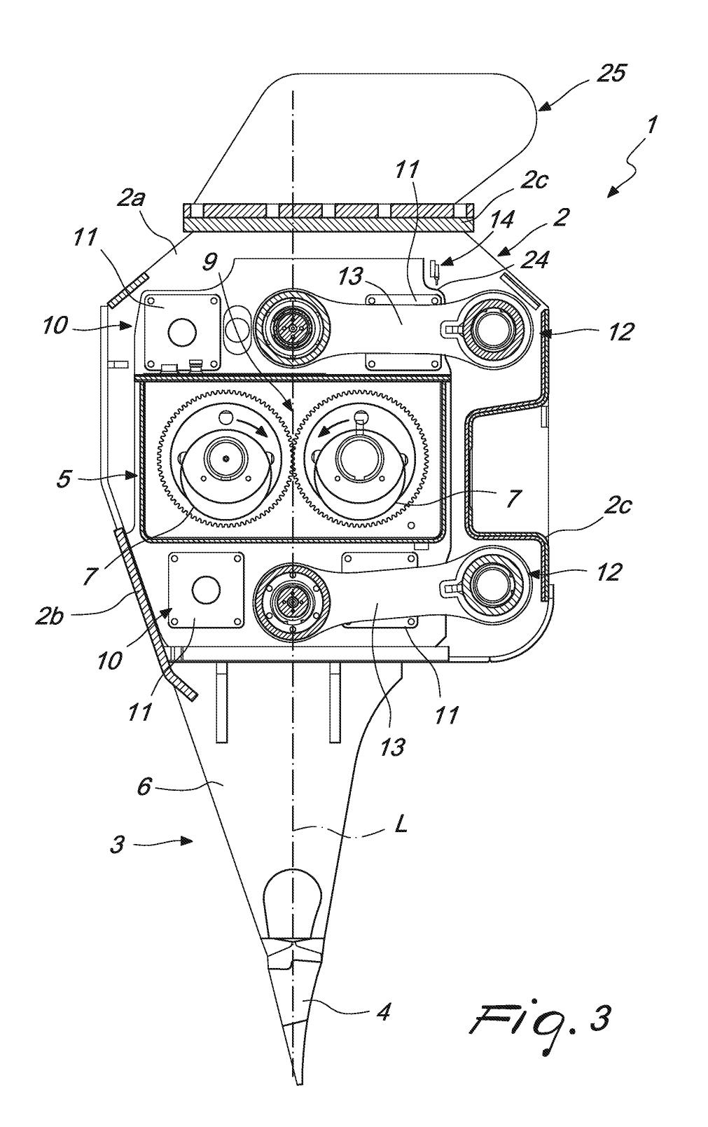

FIG. 2 is an enlarged-scale view of a portion of FIG. 1;

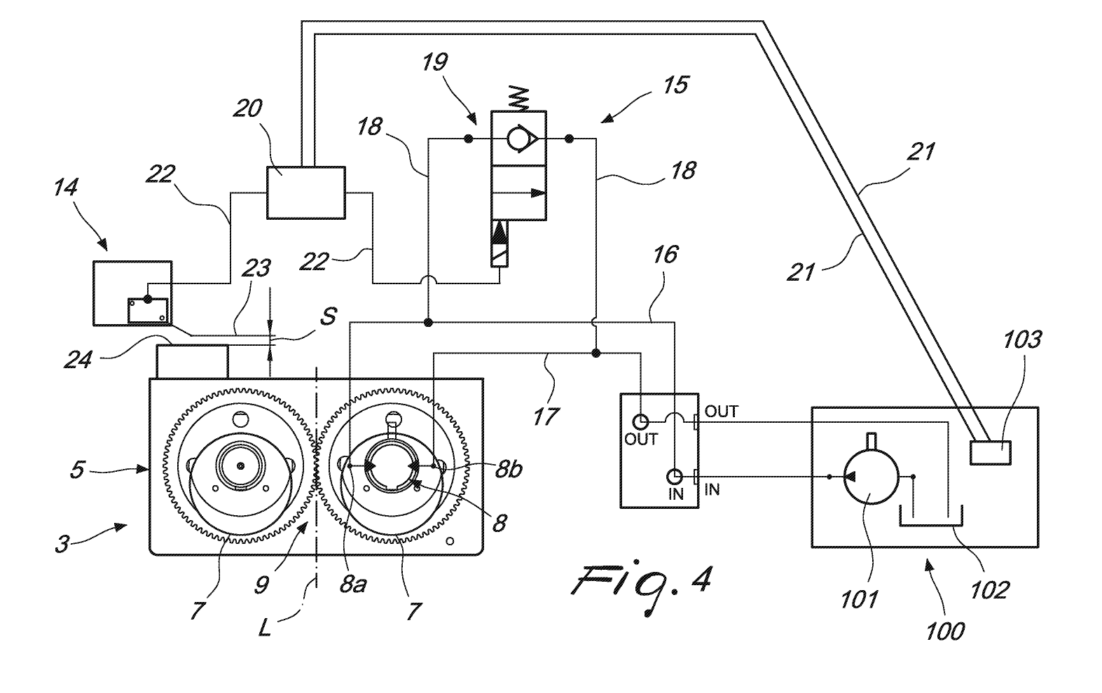

FIG. 3 is a partially sectional view of the ripper according to the invention;

FIG. 4 is a schematic view of the hydraulic circuit of the ripper according to the invention in normal operating conditions;

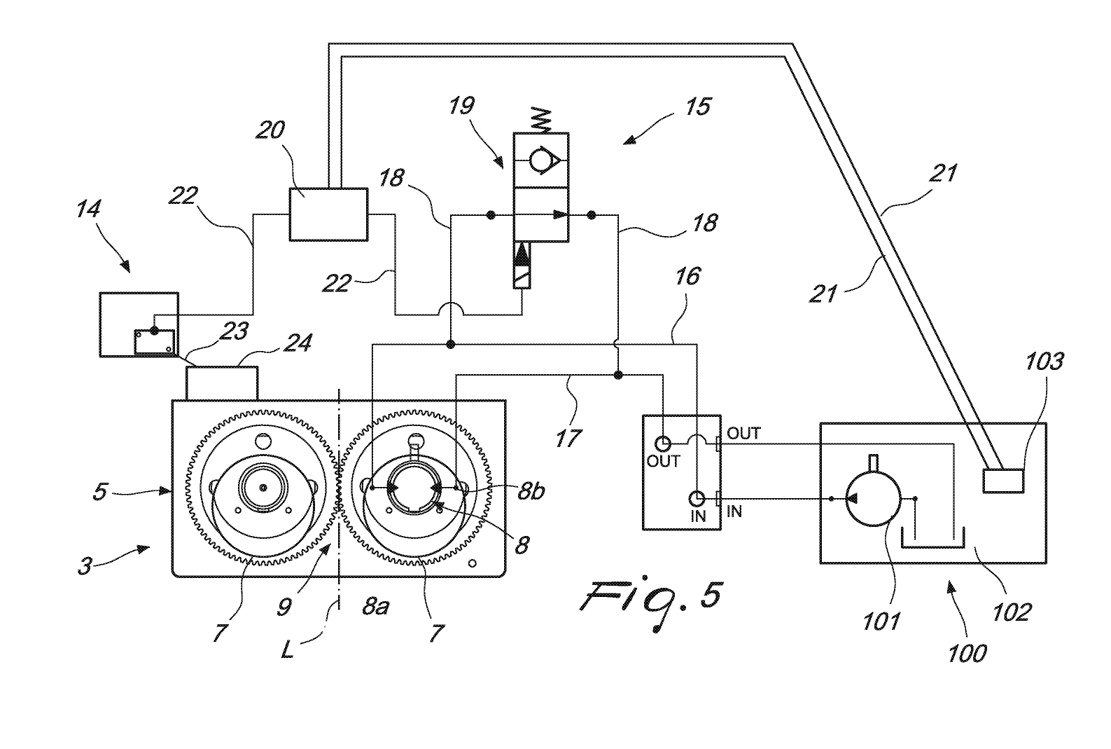

FIG. 5 is a schematic view of the hydraulic circuit of the ripper according to the invention in abnormal operating conditions.

With reference to the figures, a vibrating ripper for demolition is generally designated by the numeral 1.

The ripper 1 comprises a chassis 2, a vibrating assembly 3 supported by the chassis 2 so that it can move with an alternating translational motion along a work direction L between a first stroke limit position and a second stroke limit position, and at least one tool 4, of the type of a demolition tooth, associated with the vibrating assembly 3. In the second stroke limit position, the vibrating assembly 3 with the tool 4 are more spaced from the chassis 2 with respect to the first stroke limit position so as to penetrate into the material to be removed.

Generally, the chassis 2 comprises a substantially box-like body composed of a pair of opposite walls 2a, between which a pair of likewise opposite connecting sides 2b are interposed, and a covering face 2c. Opposite the face 2c, along the work direction L, the chassis 2 remains open to allow the movement of the vibrating assembly 3.

The vibrating assembly 3 essentially comprises a main body 5 accommodated between the walls 2a and the sides 2b, from which a tab 6 protrudes which exits from the opening of the chassis 2 and it is connected to the tool 4.

The vibrating assembly 3 comprises at least one pair of oppositely rotating eccentric masses 7, which are actuated rotationally by at least one motor element 8 and are associated with the main body 5. In the illustrated embodiment, the motor element 8 is directly mated to the rotation axis of an eccentric mass 7 and transmits the rotation to the other eccentric mass 7 by means of a gear 9 interposed between the corresponding rotation axes. A different positioning of the motor element 8 or a different configuration of the means for transmitting the rotation to the rotation axes of the eccentric masses 7 is in any case not excluded. As an alternative, there might also be a motor element for each eccentric mass, i.e., mated either to the rotation axis of an auxiliary gear acting as rotation rate step-up or step-down system associated in turn associated with the axes of the eccentric masses 7. Finally, it is possible to provide two or more pairs of oppositely rotating eccentric masses 7 associated with the main body 5.

The motor element 8 is typically of the fluid-operated type, preferably hydraulically-operated, and comprises an inlet 8a and an outlet 8b which are in a fluid connection, respectively, to a high-pressure line 16 and to a low-pressure line 17 in which a working fluid (hydraulic oil) flows at different pressures.

Moreover, vibration damping means 10 are generally provided between the vibrating assembly 3 and the chassis 2. In the illustrated embodiment, such damping means 10 comprise four elastic suspensions 11 interposed between the main body 5 and each one of the walls 2a, only four of which are visible in FIG. 3. Alternative embodiments which provide, for example, a different number and/or a different arrangement of the elastic suspensions are in any case not excluded.

Moreover, the ripper comprises constraint means 12 with one degree of freedom in alternating translational motion along the work direction L, which are interposed between the chassis 2 and the vibrating assembly 3, so as to make the vibrating assembly 3 integral with the chassis 2 along directions which are transverse to the work direction L. Said constraint means 12 can provide, for example, a pair of parallel linkages 13 of equal length, each one of which has the opposite ends pivoted, respectively, to the walls 2a and to the main body 5 to define an articulated parallelogram composed of the chassis 2, the vibrating assembly 3 and the linkages 13. The pivots of the linkages 13 to the main body 5 are arranged along the work direction L, transversely thereto, so as to allow an alternating translational motion of the vibrating assembly 3 along said direction.

However, alternative functionally equivalent embodiments of the constraint means 12 are not excluded.

In use, the ripper 1 is generally connected to the work arm of a conventional excavator 100, not shown in detail, by virtue of connection means 25 associated with the chassis 2. The connection means 25 are associated with the face 2c externally to the chassis 2. The shape of the connection means 25 can vary as a function of the characteristics of the work arm to which the ripper 1 is to be mated.

In use, the high-pressure line 16 and the low-pressure line 17 can be associated in fluid communication respectively with a feed pump 101 and with a discharge tank 102 provided on board the excavator 100.

However, it is not excluded that the ripper 1 might have a hydraulic circuit of its own, independent of the one of the excavator to which it is connected in use.

Usefully, the ripper 1 comprises, moreover, means 14 for detecting an abnormal movement S of the vibrating assembly 3 along the work direction L beyond at least one of the stroke limit positions, which are functionally associated with means 15 for the at least partial and at least temporary reduction of the supply power of the at least one motor element 8.

The reduction means 15 comprise a bypass branch 18 which is interposed between the lines 16 and 17 and is affected by valve means 19 for controlling the flow through the branch, which are normally in the closed configuration to prevent the passage of fluid (hydraulic oil) and are adapted to be switched in the open configuration by the detection means 14 in case of abnormal movement of the vibrating assembly 3.

In the open configuration, the valve means 19 can be completely open to discharge the entire flow of fluid (hydraulic oil) that arrives from the high-pressure line 16 into the low-pressure line 17. In this case, the power supply of the motor element 8 is at least temporarily interrupted when the valve means 19 are in the open configuration.

As an alternative, in the open configuration the valve means 19 can be partially open to discharge a portion of the flow of fluid (hydraulic oil) that arrives from the high-pressure line 16 into the low-pressure line 17. In this case, the power supply of the motor element 8 is at least temporarily reduced when the valve means 19 are in the open configuration.

In the illustrated embodiment, the valve means 19 are constituted by an electrically-actuated flow control valve and an electric cable 22 for connecting the detection means 14 and the actuation elements of said valve.

However, it is not excluded that the valve means 19 might provide an opening actuation of the mechanical or fluid-operated type.

Usefully, the reduction means 15 can comprise timer means 20 arranged along the electric cable 22 and functionally associated with the detection means 14 and with the valve means 19, which are activated by the detection means 14 in order to switch and keep the valve means 19 in the open configuration for a predefined time.

The timer means 20 are electrically powered and are connected to wiring 21 for connection to a power supply battery 103 generally provided on board the excavator 100. It is not excluded, however, that the timer means 20 might be associated with an electric power source of their own or one which is independent of the excavator 100.

If the timer means 20 are not present, the detection means 14 can be connected directly to the valve means 19 in order to activate their switching to the open position. In this case, further commands that can be actuated by the operator must be provided in order to return the valve means 19 to the closed configuration and allow the normal operation of the ripper 1.

The detection means 14 can provide at least one switch 23 associated with the chassis 2, internally to one of the walls 2a, which is adapted to be activated following interference with the vibrating assembly 3 if it performs a movement S beyond at least one of the stroke limit positions. In particular, the main body 5 can provide an abutment element 24 adapted to interact with the switch 23. The abutment element 24 can be applied to the main body 5, or can be integral therewith.

In case of activation of the switch 23, via the electric cable 22, an electric current signal is sent to activate the timer means 20 and consequently switch the valve means 19 to the open position.

As an alternative, the detection means 14 can provide, for example, a proximity sensor associated with the chassis 2 and adapted to detect an abnormal movement S of the vibrating assembly 3 beyond at least one of the stroke limit positions.

In particular, the detection means 14 are adapted to detect a movement S of the vibrating assembly 3 beyond the first stroke limit position in the direction of approach to the chassis 2 and, during use, to the work arm of the excavator 100.

In this manner it is possible to avoid the transmission of unwanted stresses to the excavator if the tool 4 strikes a portion of material having greater hardness and/or compression strength than the one for which the ripper 1 is sized and, as a result of the reaction provided by said material to the action of the tool 4, the vibrating assembly 3 tends to “rebound” toward the arm of the excavator.

In the illustrated embodiment, in fact, there is a switch 23 which is associated with the inside of one of the walls 2a proximate to the face 2c and is adapted to interact with an abutment surface 24 of the main body 5.

It is not excluded, in any case, that the detection means 14 might detect abnormal movements of the vibrating assembly 3, also or only, beyond the second stroke limit portion, in the direction away from the chassis 2.

The operation of the present invention is as follows.

If the ripper 1 operates in normal operating conditions, i.e., with the vibrating assembly 3 performing oscillations of predefined maximum breadth and comprised between the first stroke limit position and the second stroke limit position, the valve means 19 remain in the closed configuration (FIG. 4) and the motor element 8 is powered via the high-pressure line 16 with the nominal flow of fluid (hydraulic oil).

If anomalies occur, such that the vibrating assembly 3 performs a movement S beyond at least one of the stroke limit positions (in particular the first one), the detection means 14 detect this potentially dangerous situation and activate the switching of the valve means 19 in the open configuration (FIG. 5).

In this condition, the power supply of the motor element 8 is reduced (if the valve means 19 are only partially open) or interrupted (if the valve means 19 are completely open) for a predefined time (if the timer means 20 are provided), i.e., until the operator intervenes to actuate the return of the valve means 19 to the closed configuration.

In practice it has been found that the described invention achieves the intended aim and objects and in particular the fact is stressed that the ripper according to the invention allows to intervene in an automatic and prompt manner if an abnormal operation of the ripper occurs, so as to avoid inconvenience for the assigned operators and/or the risk of damage of components of said ripper or of the excavator to which is mated.

Furthermore, the solution according to the invention can be replicated both on newly built rippers and on already-existing rippers simply by adding some components (detection means and reduction means) and with minimal structural modifications.

The invention thus conceived is susceptible of numerous modifications and variations, all of which are within the scope of the appended claims.

All the details may furthermore be replaced with other technically equivalent elements.

In practice, the materials used, as well as the contingent shapes and dimensions, may be any according to the requirements without thereby abandoning the protective scope of the claims that follow.

The disclosures in Italian Patent Application No. 102018000004470 from which this application claims priority are incorporated herein by reference.

What is claimed is:

1. A vibrating ripper for demolition comprising a chassis, a vibrating assembly supported by said chassis so that it can move with an alternating translational motion along a work direction between a first stroke limit position and a second stroke limit position, in the second stroke limit position the vibrating assembly being spaced further from the chassis with respect to the first stroke limit position, and at least one demolition tool associated with said vibrating assembly, the vibrating assembly comprising a main body associated with at least one pair of oppositely rotating eccentric masses which are actuated rotationally by at least one motor element, further comprising means for detecting an abnormal movement of said vibrating assembly along said work direction beyond at least one of said stroke limit positions, which are functionally associated with means for the at least partial and at least temporary reduction of the supply power of said at least one motor element.

2. The ripper according to claim 1, wherein said at least one motor element is of the fluid-operated type and is provided with an inlet and with an outlet which are respectively in a fluid connection to a high-pressure line and to a low-pressure line, in which a working fluid flows at different pressures, and in that the reduction means comprise a bypass branch which is interposed between said high-pressure line and said low-pressure line and is affected by valve means for controlling the flow through said branch, which are normally in the closed configuration and are adapted to be activated for opening by said detection means in case of abnormal movement of said vibrating assembly.

3. The ripper according to claim 2, wherein in said open configuration said valve means are fully open, so as to discharge completely the flow of fluid that arrives from the high-pressure line into the low-pressure line.

4. The ripper according to claim 2, wherein in said open configuration said valve means are at least partially open, so as to discharge partially the flow of fluid that arrives from the high-pressure line into the low-pressure line.

5. The ripper according to claim 2, wherein said reduction means comprise timer means functionally associated with said detection means and with said valve means, which are activated by the detection means in order to switch and keep the valve means in the open configuration for a predefined time.

6. The ripper according to claim 1, wherein said detection means comprise at least one switch associated with said chassis, which is adapted to be activated in case of displacement of said vibrating assembly beyond at least one of said stroke limit positions.

7. The ripper according to claim 1, wherein said detection means comprise at least one proximity sensor associated with said chassis, which is adapted to detect an abnormal displacement of said vibrating assembly beyond at least one of said stroke limit positions.

8. The ripper according to claim 1, wherein said detection means are adapted to detect a displacement of said vibrating assembly beyond said first stroke limit position in the direction of approach to said chassis.

9. The ripper according to claim 1, further comprising vibration damping means interposed between said vibrating assembly and said chassis.

10. The ripper according to claim 1, further comprising constraint means with one degree of freedom in alternating translational motion along said work direction which are interposed between said chassis and said vibrating assembly.

11. The ripper according to claim 1, wherein said chassis comprises connection means which can be associated with the work arm of an excavator.

12. An excavator provided with a work arm, further comprising a ripper according to claim 1, having the corresponding chassis associated with said arm by virtue of said connection means.
